(19) United States
(12) Patent Application Publication
(10) Pub. No.: US 2014/0253131 A1
(43) Pub. Date: Sep. 11, 2014

(54) Apparatus and Method for Directional Resistivity Measurement While Drilling Using Slot Antenna

(71) Applicants: Ce Liu, Sugar Land, TX (US); Jing Li, Houston, TX (US)

(72) Inventors: Ce Liu, Sugar Land, TX (US); Jing Li, Houston, TX (US)

(21) Appl. No.: 13/786,318

(22) Filed: Mar. 5, 2013

(51) Int. Cl. G01V 3/30

(52) U.S. Cl. CPC G01V 3/30
USPC 324/338

(57) ABSTRACT

An apparatus for making directional resistivity measurements of a subterranean formation includes a resistivity tool with a longitudinal axis and an outer surface, multiple slots formed on the outer surface of the resistivity tool and oriented substantially parallel to the longitude axis of the resistivity tool, and multiple wires posited in the slots and electrically connecting end walls of the slots to form magnetic dipole antennas. The mantic dipole antennas form at least one transmitter-receiver antenna group to perform transmission and reception of electromagnetic signals. A corresponding method for making directional resistivity measurements is also provided.

### FIELD OF THE INVENTION

The present invention relates generally to the field of electrical resistivity well logging. More particularly, the invention relates to an apparatus and a method for providing a directional resistivity tool with a slot antenna to make directional resistivity measurements of a subterranean formation.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, the resistivity is an important parameter in delineating hydrocarbon (such as crude oil or gas) and water contents in the porous formation.

With the development of modern drilling and logging technologies, “horizontal drilling,” which means drilling wells at less of an angle with respect to the geological formation, is getting popular because it can increase exposed length of the pay zone (the formation with hydrocarbons). It is preferable to keep the borehole in the pay zone as much as possible so as to maximize the recovery. Therefore, a directional resistivity tool with azimuthal sensitivity is needed to make steering decisions for subsequent drilling of the borehole. The steering decisions can be made upon measurement results of bed boundary identification, formation angle detection, and fracture characterization.

Directional resistivity measurements commonly involve transmitting and/or receiving transverse (x-mode or y-mode) or mixed mode (e.g. mixed x- and z-mode) electromagnetic waves. Various antenna configurations are well known for making such measurements, such as a transverse antenna configuration (x-mode) shown in FIG. 1A, a bi-planer antenna configuration shown in FIG. 1B, a saddle antenna configuration (x-mode and z-mode, mixed mode) shown in FIG. 1C, and a tilted antenna shown in FIG. 1D. The magnetic moment of the transverse antenna shown in FIG. 1A points to a direction that is perpendicular to the longitudinal axis of a directional resistivity tool with which the transverse antenna deployed. The bi-planer antenna, the saddle antenna, and the tilted antenna configuration shown in FIGS. 1B, 1C, and 1D can transmit or receive transverse components of magnetic fields to make azimuthal resistivity measurements.

As described above, although the directional resistivity tools have been used commercially, a need still exists for an improved antenna configured in a directional resistivity tool.

A further need exists for an improved antenna with a simpler configuration to be easily deployed with a directional resistivity tool.

A further need exists for an improved antenna which is cost effective and easy to manufacture.

The present embodiments of the apparatus and the method meet these needs, and improve on the technology.

### SUMMARY OF THE INVENTION

This section provides a general summary of the disclosure, and is not a comprehensive disclosure of its full scope or its entire features.

In one preferred embodiment, a method for making directional resistivity measurements of a subterranean formation includes rotating a resistivity tool in a borehole, transmitting electromagnetic signals from a first slot antenna deployed on the resistivity tool, receiving the electromagnetic signals on a second slot antenna deployed on the resistivity tool, extracting a sinusoidal wave from induced voltages on the second slot antenna during a rotation round of the resistivity tool, deriving information of the orientation of a formation boundary, extracting peak-valley amplitudes of induced voltages on the second slot antenna during the rotation round of the resistivity tool and a rotation angle, and deriving information of distance and direction to the formation boundary.

In some embodiments, the first and the second slot antennas are recessed regions formed on an outer surface of the resistivity tool with a wire posited inside.

In some embodiments, the wire electrically connects an end wall of the recessed region to the center conductor of a coaxial connector at the other end of the recessed region and generates magnetic fields as a magnetic dipole.

In some embodiments, the coaxial connector links the wire in the recessed region to a circuit for signal transmission.

In another preferred embodiment, a magnetic dipole antenna deployed in a resistivity tool with a longitudinal axis and an outer surface includes an indentation formed on the outer surface of the resistivity tool, a coaxial connector deployed under the outer surface of the resistivity tool, and a wire posited in the indentation and electrically connecting an end wall of the indentation and the center conductor of the coaxial connector at the other end of the indentation. The indentation and the wire form a magnetic dipole to transmit or receive electromagnetic signals.

In some embodiments, the magnetic dipole antenna further includes a magnetically permeable material filled in the indentation.

In some embodiments, the permeable material is a magnetic material for enhancing transmission and reception of the magnetic dipole.

In some embodiments, the magnetic material is selected form the group consisting of a ferrite material, an electrically non-conductive magnetic alloy, an iron powder, and a nickel iron alloy.

In some embodiments, the magnetic dipole antenna further includes a protective material filled in the indentation.

In other embodiments, the protective material is epoxy resin.

In other embodiments, the indentation is circular shaped.

In other embodiments, the indentation is rectangular shaped.

In still other embodiments, the magnetic dipole antenna further includes multiple grooves formed on the outer surface and across the indentation on the resistivity tool to enhance transmission and reception of electromagnetic signals.

In still other embodiments, the groove is oval shaped.

In still another preferred embodiment, an apparatus for making directional resistivity measurements of a subterranean formation includes a resistivity tool with a longitudinal axis and an outer surface, multiple slots formed on the outer surface of the resistivity tool and oriented substantially parallel to the longitude axis of the resistivity tool, and multiple wires posited in the slots and electrically connecting end walls of the slots to form magnetic dipole antennas. The magnetic dipole antennas form at least one transmitter-receiver antenna group to perform transmission and reception of electromagnetic signals.

In some embodiments, the apparatus further includes a coaxial connector to connect the wires with a circuit for processing the electromagnetic signals to be transmitted or received.

In some embodiments, the apparatus further includes multiple grooves formed on the outer surface and cross the slots on the resistivity tool to enhance transmission and reception of the electromagnetic signals.

In some embodiments, the grooves are substantially transverse to the slots on the resistivity tool.

In other embodiments, the apparatus further includes a magnetically permeable material filled in the slots.

In still other embodiments, the apparatus further includes a protective material filled in the slots.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1A illustrates a prior art of a transverse mode coil antenna in conventional resistivity tool.

FIGS. 1B, 1C, and 1D illustrate prior arts of antenna embodiments that could radiate or receive transverse components of the magnetic fields for making azimuthal resistivity measurements.

FIG. 2 illustrates a front view of a directional resistivity tool assembled with a conventional logging while drilling system.

FIG. 3A illustrates a perspective view of the directional resistivity tool with a slot antenna shown in FIG. 2 according to some embodiments of the present invention.

FIG. 3B illustrates a cross-sectional view of the slot antenna taken along line AA′ as shown in FIG. 3A.

FIG. 3C illustrates a cross-sectional view of the slot antenna taken along line BB′ as shown in FIG. 3A.

FIG. 4A illustrates a directional resistivity tool deployed with a slot antenna and multiple transverse grooves according to other embodiments of the present invention.

FIG. 4B illustrates a cross-sectional view of the slot antenna taken along line CC′.

FIG. 5A illustrates a perspective view of the directional resistivity tool with a pair of a transmitter antenna and a receiver antenna according to some embodiments of the present invention.

FIG. 5B illustrates a perspective view of the directional resistivity tool with a pair of a transmitter antenna and a receiver antenna, which are deployed with multiple transverse grooves, according to other embodiments of the present invention.

FIG. 6A illustrates radiated vector magnetic fields generated by the transmitter antenna shown in FIG. 5B.

FIG. 6B illustrates radiated field strength in the azimuthal plane generated by the transmitter antenna shown in FIG. 5B.

FIG. 7 illustrates the directional resistivity tool shown in FIG. 5B operating in a simulation model, which is for demonstrating the azimuthal sensitivity of the directional resistivity tool according to some embodiments of the present invention.

FIG. 8A illustrates simulation results of the model in FIG. 7 in term of a data graph of the imaginary part of the induced voltage on the receiver antenna versus rotation angle of the directional resistivity tool.

FIG. 8B illustrates simulation results of the model in FIG. 7 in term of a data graph of the real part of the induced voltage on the receiver antenna versus rotation angle of the directional resistivity tool.

FIG. 9 illustrates simulation results of the model in FIG. 7 in term of a data graph of the amplitude of the induced voltage on the receiver antenna versus distance to a resistivity interface.

FIG. 10 illustrates a flow chart of making directional resistivity measurements according to some embodiments of the present invention.

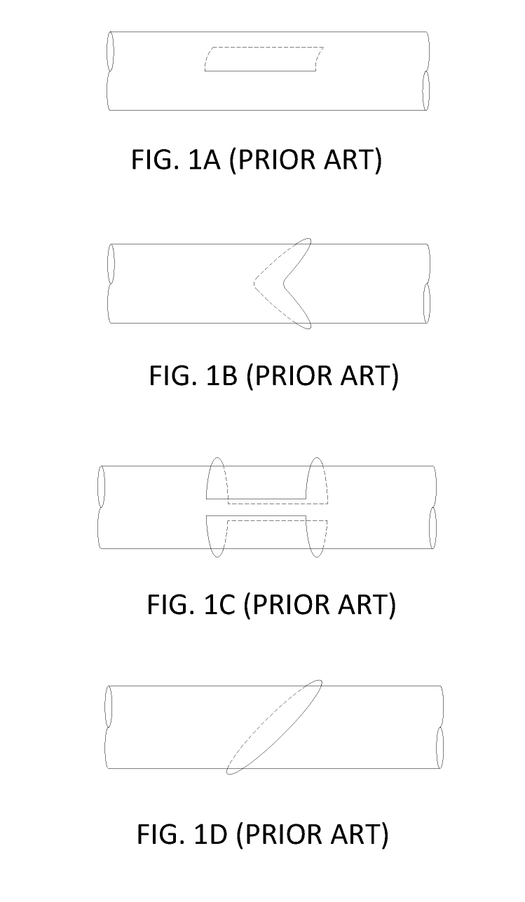

The present embodiments are detailed below with reference to the listed Figures.

### DETAILED DESCRIPTION OF THE EMBODIMENTS

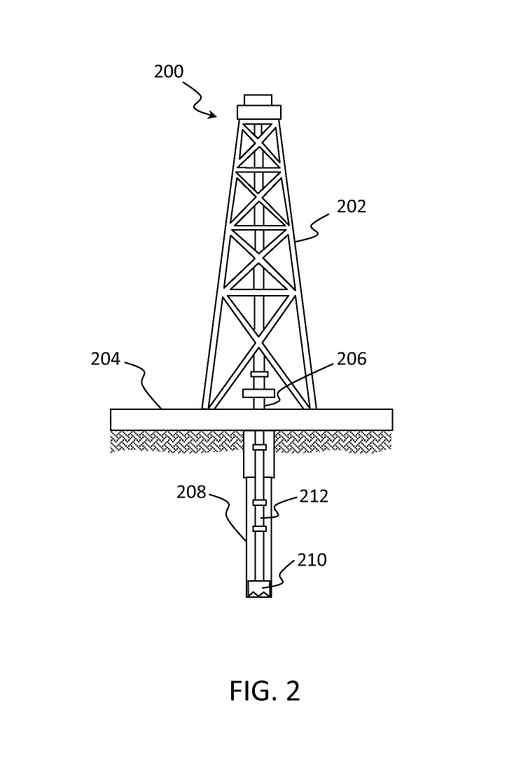

FIG. 2 illustrates a front view of a directional resistivity tool 212 assembled with a conventional logging while drilling system 200 according to some embodiments of the present invention. The conventional logging while drilling system 200 can include a drilling rig 202, a drill string 206, a drill bit 210, and a directional resistivity tool 212. The drill string 206 supported by the drilling rig 202 can extend from above a surface 204 down into a borehole 208. The drill string 206 can carry on the drill bit 210 and the directional resistivity tool 212 to make measurements of geological properties of a subterranean formation while drilling.

In some embodiments, the drill string 206 can further include a mud pulse telemetry system, a borehole drill motor, measurement sensors, such as a nuclear logging instrument, and an azimuth sensor, such as an accelerometer, a gyroscope, or a magnetometer, for facilitating measurements of surrounding formation. Also, the drill string 206 can be assembled with a hoisting apparatus for elevating or lowering the drill string 206.

The directional resistivity tool 212 according to the present invention can be applied not only to a logging while drilling (“LWD”) system, but also to a measurement while drilling (“MWD”) system and wireline applications. Also, the directional resistivity tool 212 can be equally suited for use with any kind of drilling environment, either onshore or offshore, and with any kind of drilling platform, including but not limited to, fixed, floating, and semi-submerge platforms.

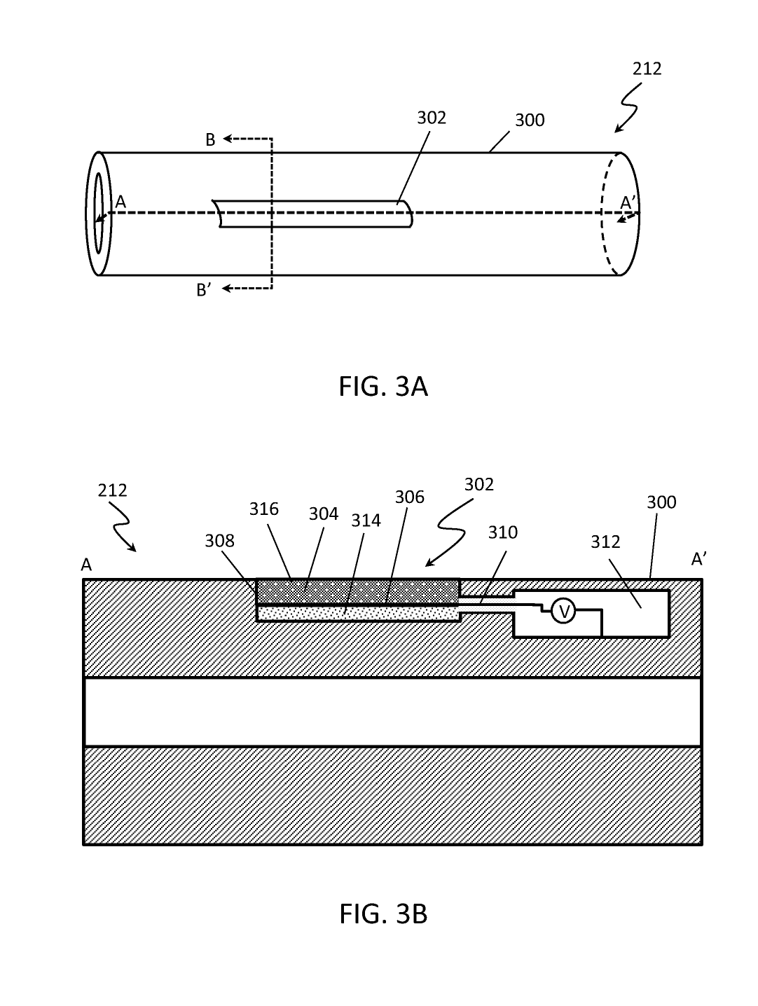

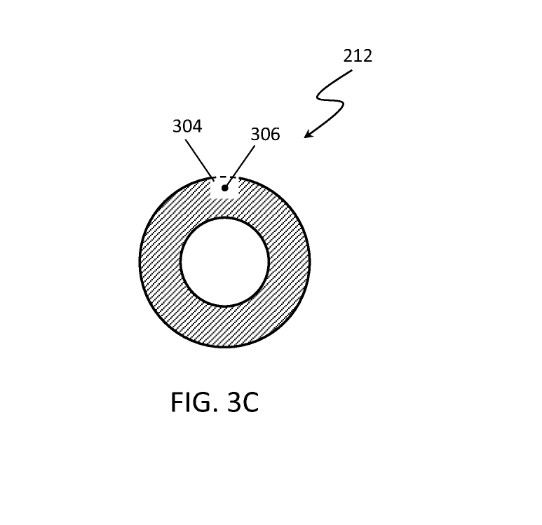

FIG. 3A illustrates a perspective view of the directional resistivity tool 212 shown in FIG. 2 according to some embodiments of the present invention. The directional resistivity tool 212 can include a slot antenna 302 to be deployed on it.

FIG. 3B illustrates a cross-sectional view of the slot antenna 302 taken along line AA′ as shown in FIG. 3A. The slot antenna 302 can be a configuration of an indentation 304 formed on an outer surface 300 of the directional resistivity tool 212 with a wire 306 posited inside. The wire 306 can electrically connect an end wall 308 of the indentation 304 with the center conductor of a coaxial connector 310 at the other end of the indentation 304. The coaxial connector 310 can link the wire 306 in the indentation 304 to a circuit chamber 312, which can be deployed outside of the indentation 304 and under the outer surface 300 of the directional resistivity tool 212.

The circuit chamber 312 can be deployed with transmitter and receiver circuits for processing electromagnetic signals to be transmitted or received.

In some embodiments, the slot antenna 302 can not only be oriented parallel with the tool axis, it can also be oriented in other directions, like perpendicular to the tool axis or located at any angle with the tool axis.

In some embodiments, a magnetically permeable material 314 can be filled in the indentation 304 to enhance transmission and reception of the slot antenna 302. The material 314 can be a magnetic material and can be deployed between the center wire and the floor of the indentation. The magnetic material can be, but is not limited to, a ferrite material, an electrically non-conductive magnetic alloy, an iron powder, and a nickel iron alloy.

In some embodiments, a protective material 316 also can be filled in the indentation 304. The protective material 316 can be for protecting the slot antenna 302 from damages caused while drilling. The protective material can be, but not limited to, epoxy resin, and can be located above the permeable material.

FIG. 3C illustrates a cross-sectional view of the slot antenna 302 taken along line BB′ as shown in FIG. 3A. The shape of the indentation 304 can vary, i.e. circular, rectangular, or any other shape.

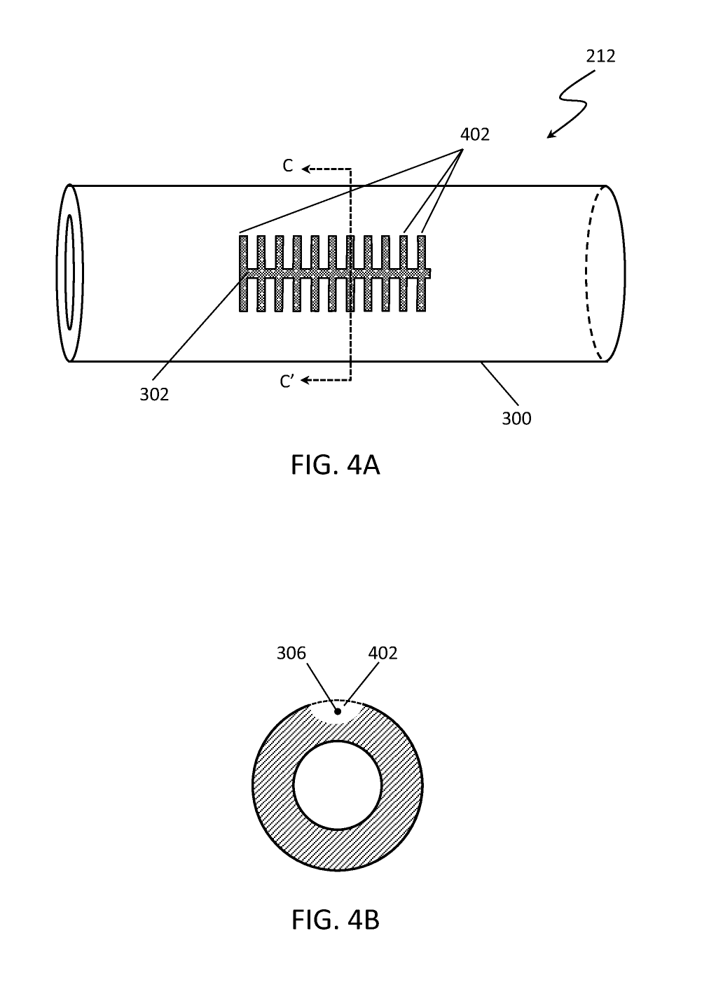

FIG. 4A illustrates a directional resistivity tool 212 deployed with a slot antenna 302 and multiple transverse grooves 402 according to other embodiments of the present invention. The multiple transverse grooves 402 can be formed on the outer surface 300 of the directional resistivity tool 212 and cross the indentation 304 to increase the indented/permeable area on the directional resistivity tool 212. In that way, the efficiency of the transmission and reception of the slot antenna 302 can be enhanced.

FIG. 4B illustrates a cross-sectional view of the slot antenna 302 taken along line CC′. The shape of the groove 402 can vary, i.e. circular, rectangular, oval, or any other shape.

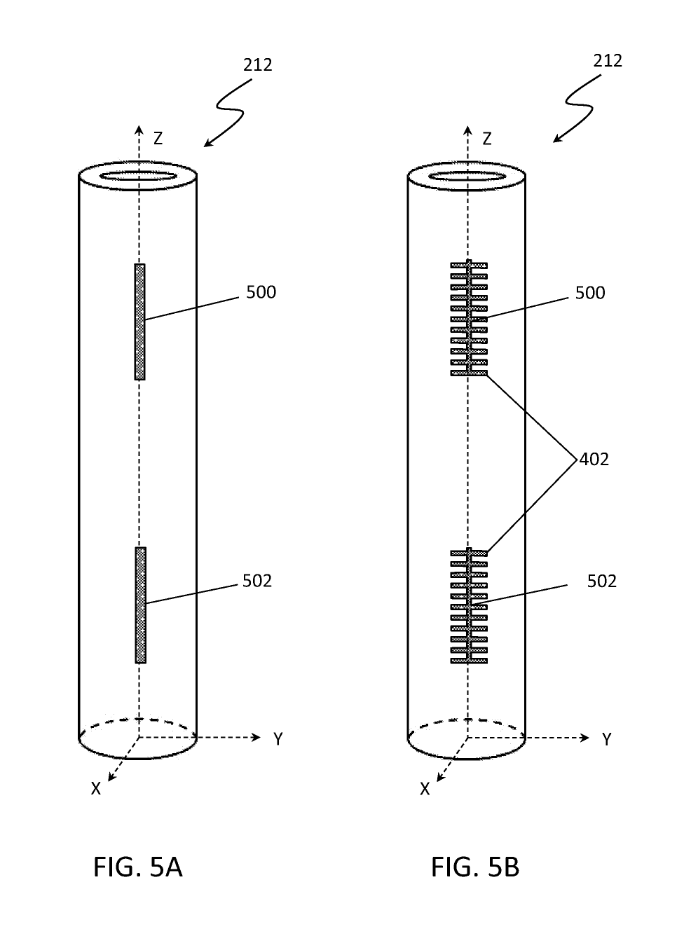

FIG. 5A illustrate a perspective view of the directional resistivity tool 212 with a pair of a transmitter antenna 500 and a receiver antenna 502 according to some embodiments of the present invention. The transmitter antenna 500 and the receiver antenna 502 can be deployed on the directional resistivity tool 212 and configured as the slot antenna 302 as illustrated in FIGS. 3A, 3B, and 3C. The transmitter antenna 500 and the receiver antenna 502 can be oriented substantially parallel to the longitudinal axis of the directional resistivity tool 212 and spaced at an axial distance from each other. In accordance with the principle of reciprocity, each antenna may be able to act as either a transmitter antenna or a receiver antenna as long as it is connected with appropriate transmitter or receiver circuits.

FIG. 5B illustrate a perspective view of the directional resistivity tool 212 with a pair of the transmitter antenna 500 and the receiver antenna 502, which can be deployed with multiple transverse grooves 402, according to other embodiments of the present invention. The grooves 402 can enhance the transmission and reception of the transmitter antenna 500 and the receiver antenna 502, as illustrated in the FIGS. 4A and 4B.

The present invention is in no way limited to any particular geometry and number of such slot antennas and grooves.

In some embodiments, either the transmitter antenna 500 or the receiver antenna 502 can be replaced with other types and shapes of antennas.

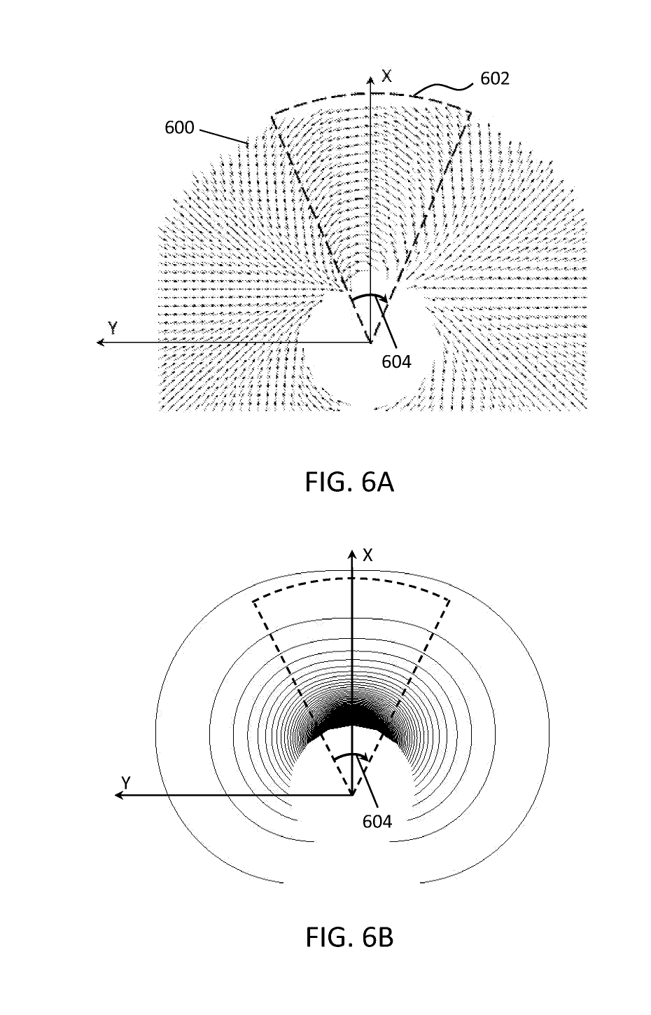

FIG. 6A illustrates radiated vector magnetic fields generated by the transmitter antenna 500 shown in FIG. 5B. Multiple arrows 600 can indicate the polarization of the magnetic field. A sector 602, which is confined by dash lines, can indicate the polarization of the magnetic field in front of the transmitter antenna 500, the axis of which is in the x direction. The arrows 600 in the sector 602 can show that the magnetic field in front of the transmitter antenna 500 can be almost polarized in the azimuthal direction and resembles the magnetic filed generated by a y-oriented magnetic dipole. In accordance with the reciprocal theory, the corresponding receiver antenna 502 would be more sensitive to a formation interface appearing within an included angle 604 of the sector 602.

FIG. 6B illustrates radiated field strength in the azimuthal plane generated by the transmitter antenna 500 shown in FIG. 5B. It can show that the most energy of the electromagnetic signals is transmitted out of the transmitter antenna 500 in the front direction (positive x direction) within the included angle 604. In view of the magnetic field polarization pattern and radiation energy pattern shown in FIGS. 6A and 6B, it can be concluded that the slot antenna configuration according to some embodiments of the present invention can be suitable for directional resistivity measurements.

In operation, the transmitter antenna 500 and the receiver antenna 502 with a slot antenna configuration can act as a magnetic dipole to transmit/receive electromagnetic signals. Accordingly, the slot antenna 302 can also be called as a slot magnetic dipole antenna. During drilling, when the directional resistivity tool approaches a resistivity interface, the induced voltage on the receiver antenna 502 can reflect the presence of the interface (through the change of amplitude attenuation and phase shift), as know in prior arts. Furthermore, the sinusoidal change of the induced voltage on the receiver antenna 502 with the rotation of the directional resistivity tool 212 can indicate the direction from the resistivity interface, as the magnetic field in front of the antennas with the slot antenna configuration can be almost polarized in the azimuthal direction.

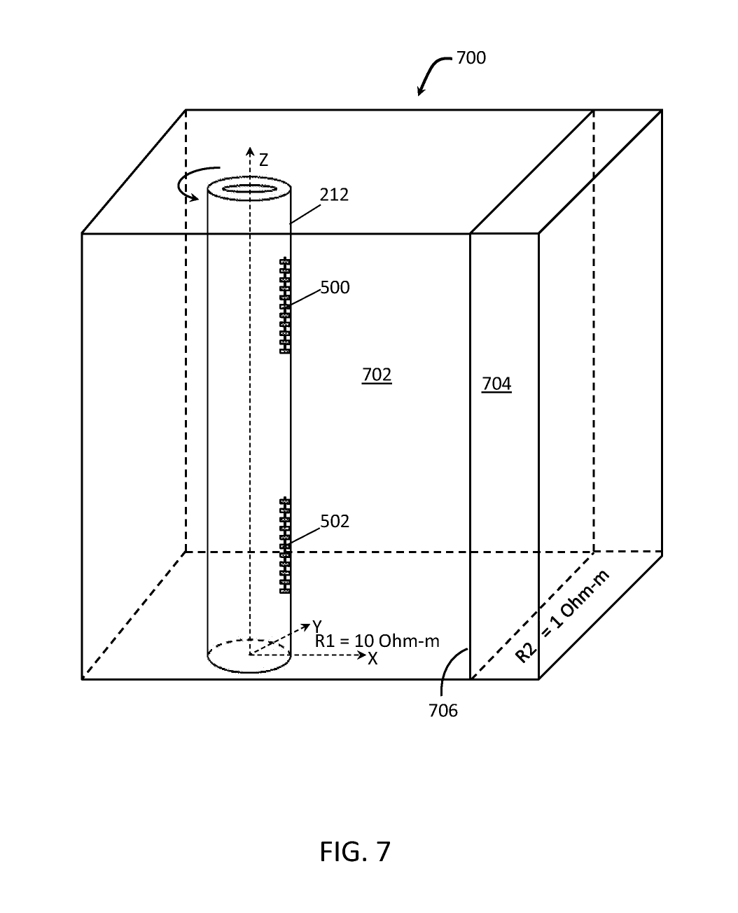

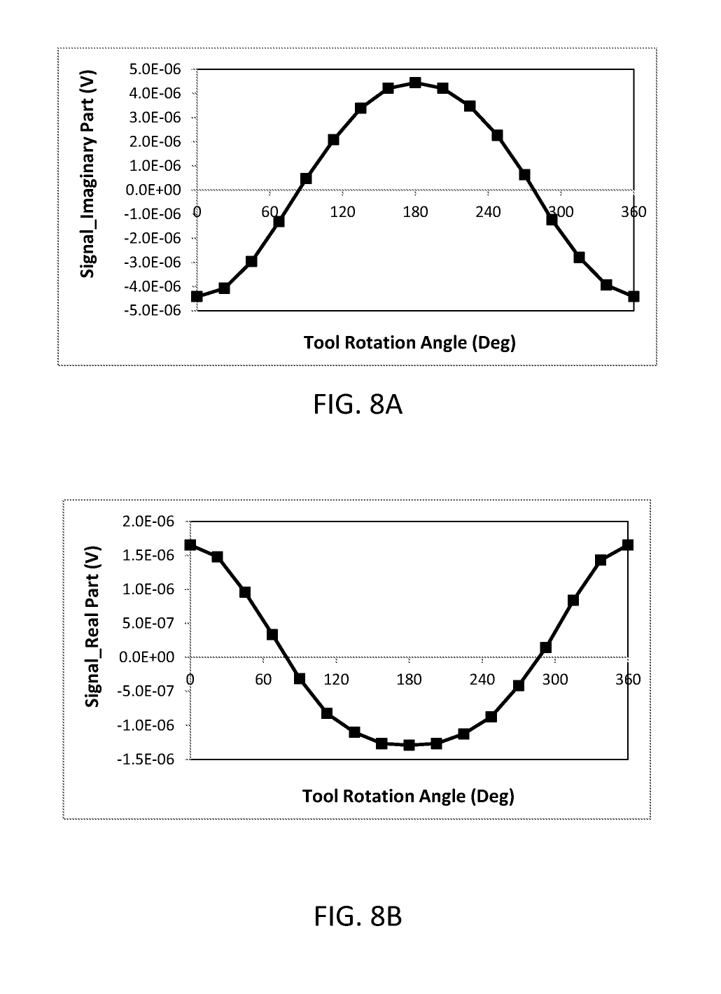

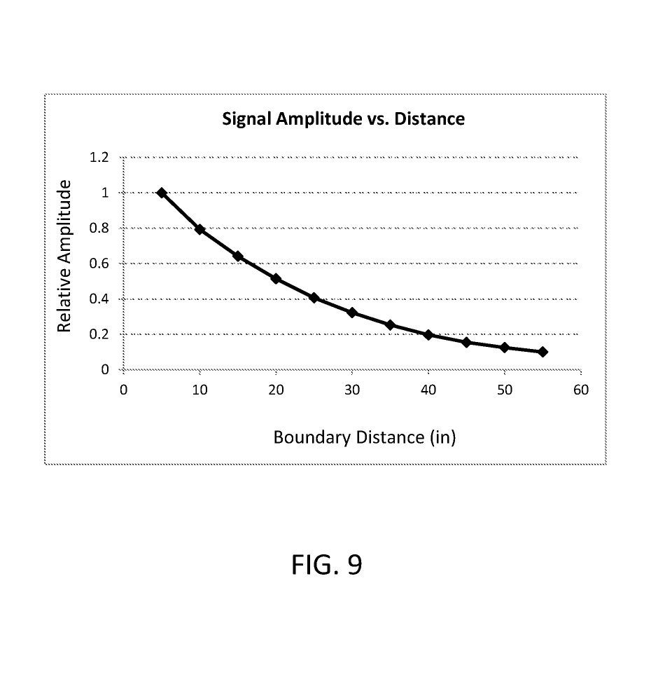

FIG. 7 illustrates the directional resistivity tool 212 shown in FIG. 5B operating in a simulation model 700, which is for demonstrating the azimuthal sensitivity of the directional resistivity tool 212 according to some embodiments of the present invention, and FIGS. 8A, 8B, and 9 show simulation results of the model 700 provided in FIG. 7. In FIG. 7, the model 700 can contain a 3D cube divided into two parts by a vertical resistivity interface 706. The left part 702 can have a resistivity of 10 ohm-m and the right part 704 can have a resistivity of 1 ohm-m. The directional resistivity tool 212 can be placed and rotate in the left part 702 approaching toward the resistivity interface 706 in the positive x direction.

FIG. 8A illustrates simulation results of the model 700 in FIG. 7 in term of a data graph of the imaginary part of the induced voltage on the receiver antenna 502 versus rotation angle of the directional resistivity tool 212. FIG. 8B illustrates simulation results of the model 700 in FIG. 7 in term of a data graph of the real part of the induced voltage on the receiver antenna 502 versus rotation angle of the directional resistivity tool 212. FIGS. 8A and 8B can show that when the directional resistivity tool 212 is close to the resistivity interface (5 ft) 706, the imaginary and real parts of the induced voltage on the receiver antenna 502 starts varying sinusoidally with the rotation angle of the directional resistivity tool 212. In that way, an appearance of the resistivity interface 706 in the path of the directional resistivity tool 212 in the front direction (positive x direction) can be identified.

FIG. 9 illustrates simulation results of the model 700 in FIG. 7 in term of a data graph of the amplitude of the induced voltage on the receiver antenna 502 versus distance to the resistivity interface 706. In accordance with the FIG. 9, the closer the directional resistivity tool 212 to the resistivity interface 706, the larger the amplitude of the induced voltage reflected on the receiver antenna 502. In fact, the results of distance from the receiver antenna 502 to the resistivity interface 706 can be derived as a function of the amplitude of the induced voltage measured on the receiver antenna 502 (“maximum voltage”, “Vₘₐₓ”), adjacent formation resistivities (“R₁, R₂”), dielectric constant (“∈₁, ∈₂”), and permeability (“μ₁, μ₂”) as follows.

d=f(Vₘₐₓ,R₁,R₂,∈₁,∈₂,μ₁,μ₂) (1)

At low frequency and in the non-magnetic formations, the resistivities of surrounding formations play dominant roles in determining the boundary distance. Equation (1) can be simplified as Equation (2) below.

d=f(Vₘₐₓ,R₁,R₂) (2)

A three-dimensional look-up table, in terms of a maximum voltage and adjacent formation resistivities, can be pre-built through forward modeling in the directional resistivity tool 212 to increase the efficiency of directional measurements. The forward model provides a set of mathematical relationships for sensor responses in different environment with different electrical properties. The maximum voltage measured on the receiver antenna 502 can be the input data of the three-dimensional look-up table and then the distance from the directional resistivity tool 212 to the resistivity interface 706 can be generated with known or derived resistivities of surrounding formations, which can be pre-built in the table or measured from other devices coupled with the directional resistivity tool 212.

As illustrated above, the sinusoidally-varying induced voltage on the receiver antenna 502 can be indicative of electrical properties of surrounding subterranean formations, including, but not limited to, the distance to and direction of the resistivity interface 706. Thus, the directional resistivity tool 212 with a slot antenna configuration has azimuthal sensitivity to make steering decisions for subsequent drilling of the borehole.

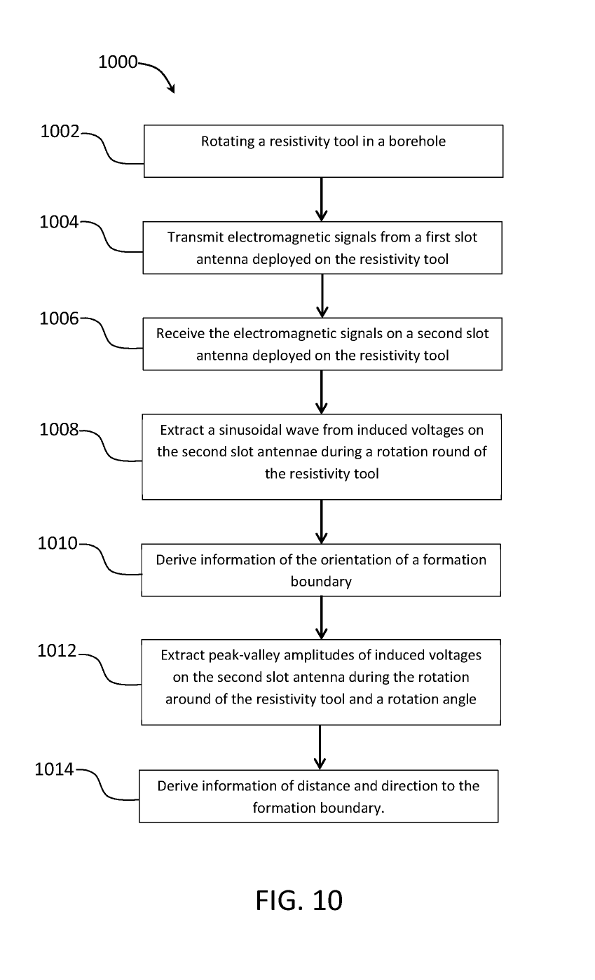

FIG. 10 illustrate of an exemplary flow chart of making directional resistivity measurements 1000 according to some embodiments of the present invention. The steps include rotating a resistivity tool in a borehole 1002, transmitting electromagnetic signals from a first slot antenna deployed on the resistivity tool 1004, receiving the electromagnetic signals on a second slot antenna deployed on the resistivity tool 1006, extracting a sinusoidal wave from induced voltages on the second slot antenna during a rotation round of the resistivity tool 1008, deriving information of the orientation of a formation boundary 1010, extracting peak-valley amplitudes of induced voltages on the second slot antenna during the rotation round of the resistivity tool and a rotation angle 1012, and deriving information of distance and direction to the formation boundary 1014.

In some embodiments, the first and the second slot antennas can be recessed regions formed on an outer surface of the resistivity tool with a wire posited inside.

In some embodiments, the wire can electrically connect an end wall of the recessed region with the center conductor of a coaxial connector at the other end of the recessed region and generate magnetic fields as a magnetic dipole.

In some embodiments, the coaxial connector can link the wire in the recessed region to a circuit for signal transmission, which can be deployed outside of the recessed region and under the outer surface of the resistivity tool.

The present invention is in no way limited to any particular order of steps or requires any particular step illustrated in FIG. 10.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method for making directional resistivity measurements of a subterranean formation comprising:
rotating a resistivity tool in a borehole;
transmitting electromagnetic signals from a first slot antenna deployed on the resistivity tool;
receiving the electromagnetic signals on a second slot antenna deployed on the resistivity tool;
extracting a sinusoidal wave from induced voltages on the second slot antenna during a rotation round of the resistivity tool;
deriving information of the orientation of a formation boundary;
extracting peak-valley amplitudes of induced voltages on the second slot antenna during the rotation round of the resistivity tool and a rotation angle; and
deriving information of distance and direction to the formation boundary.

2. The method according to claim 1 wherein the first and the second slot antennas are recessed regions formed on an outer surface of the resistivity tool with a wire posited inside.

3. The method according to claim 2 wherein the wire electrically connects an end wall of the recessed region to the center conductor of a coaxial connector at the other end of the recessed region and generates magnetic fields as a magnetic dipole.

4. The method according to claim 3 wherein the coaxial connector links the wire in the recessed region to a circuit for signal transmission.

5. An magnetic dipole antenna deployed in a resistivity tool with a longitudinal axis and an outer surface, comprising;
an indentation formed on the outer surface of the resistivity tool;
a coaxial connector deployed under the outer surface of the resistivity tool;
a wire posited in the indentation and electrically connecting an end wall of the indentation and the center conductor of the coaxial connector at the other end of the indentation; and
wherein the indentation and the wire forms a magnetic dipole to transmit or receive electromagnetic signals.

6. The magnetic dipole antenna according to claim 5 further comprises a magnetically permeable material filled in the indentation.

7. The magnetic dipole antenna according to claim 6 wherein the magnetically permeable material is a magnetic material for enhancing transmission and reception of the magnetic dipole.

8. The magnetic dipole antenna according to claim 7 wherein the magnetic material is selected form the group consisting of a ferrite material, an electrically non-conductive magnetic alloy, an iron powder, and a nickel iron alloy.

9. The magnetic dipole antenna according to claim 5 further comprises a protective material filled in the indentation.

10. The magnetic dipole antenna according to claim 9 wherein the protective material is epoxy resin.

11. The magnetic dipole antenna according to claim 5 wherein the indentation is circular shaped.

12. The magnetic dipole antenna according to claim 5 wherein the indentation is rectangular shaped.

13. The magnetic dipole antenna according to claim 5 further comprises multiple grooves formed on the outer surface and across the indentation on the resistivity tool to enhance transmission and reception of electromagnetic signals.

14. The magnetic dipole antenna according to claim 13 wherein the groove is oval shaped.

15. An apparatus for making directional resistivity measurements of a subterranean formation comprising:
a resistivity tool with a longitudinal axis and an outer surface;
multiple slots formed on the outer surface of the resistivity tool and oriented substantially parallel to the longitude axis of the resistivity tool;
multiple wires posited in the slots and electrically connecting end walls of the slots to form magnetic dipole antennas; and
wherein the mantic dipole antennas form at least one transmitter-receiver antenna group to perform transmission and reception of electromagnetic signals.

16. The apparatus according to claim 15 further comprises a coaxial connector to connect the wires with a circuit for processing the electromagnetic signals to be transmitted or received.

17. The apparatus according to claim 15 further comprises multiple grooves formed on the outer surface and cross the slots on the resistivity tool to enhance transmission and reception of the electromagnetic signals.

18. The apparatus according to claim 17 wherein the grooves are substantially transverse to the slots on the resistivity tool.

19. The apparatus according to claim 15 further comprises a magnetically permeable material filled in the slots.

20. The apparatus according to claim 15 further comprises a protective material filled in the slots.
